(19) United States
(12) Patent Application Publication
(10) Pub. No.: US 2025/0388026 A1
(43) Pub. Date: Dec. 25, 2025

(54) IMAGE FORMING APPARATUS CAPABLE OF SUPPRESSING GENERATION OF STREAK IMAGE, AND ADJUSTMENT METHOD

(71) Applicant: KYOCERA Document Solutions Inc., Osaka (JP)

(72) Inventor: Shinji Nakatsuka, Osaka (JP)

(21) Appl. No.: 19/237,438

(22) Filed: Jun. 13, 2025

(30) Foreign Application Priority Data
Jun. 21, 2024 (JP) 2024-100382

(51) Int. Cl. B41J 2/21; G06K 15/02; G06T 7/00

(52) U.S. Cl. CPC B41J 2/2139; B41J 2/2135; B41J 2/2142; B41J 2/2146; G06K 15/027; G06T 7/0004; G06K 2215/101; G06T 2207/30144

(57) ABSTRACT

An image forming apparatus includes an ejection portion, an acquisition processing portion, a detection processing portion, and an adjustment processing portion. The ejection portion includes a plurality of nozzles arranged along a width direction and causes ink to be ejected from each of the nozzles based on halftone image data. The acquisition processing portion acquires test halftone image data that is generated by an image generation apparatus. The detection processing portion detects a defective nozzle based on a result of reading a first test image corresponding to the test halftone image data and predetermined second test images corresponding to the nozzles, the first test image and the second test images being formed on a print medium by the ejection portion. The adjustment processing portion increases an ejection amount of the ink by the nozzle adjacent to the defective nozzle.

### INCORPORATION BY REFERENCE

This application is based upon and claims the benefit of priority from the corresponding Japanese Patent Application No. 2024-100382 filed on Jun. 21, 2024, the entire contents of which are incorporated herein by reference.

### BACKGROUND

The present disclosure relates to an image forming apparatus and an adjustment method.

An image forming apparatus such as a printer forms an image on a print medium such as a sheet based on halftone image data. For example, there is known an image forming apparatus including an ejection portion which includes a plurality of nozzles arranged along a width direction orthogonal to a conveying direction of the print medium and causes ink to be ejected from each of the nozzles based on the halftone image data. There is also known an image forming apparatus which is communicably connected to an external image generation apparatus such as a DFE (Digital Front End) that generates the halftone image data.

There is also known an image forming apparatus which detects an abnormal nozzle that cannot eject ink contained in the plurality of nozzles normally based on a result of reading a predetermined image that is formed on the print medium by the ejection portion and corresponds to each of the nozzles. In this type of image forming apparatus, when the abnormal nozzle is detected, an ejection amount of ink by the nozzle adjacent to the abnormal nozzle is increased. This suppresses generation of a low-concentration streak image along the conveying direction in the image formed by the image forming apparatus.

### SUMMARY

An image forming apparatus according to an aspect of the present disclosure is an image forming apparatus which is communicably connected to an image generation apparatus which generates halftone image data and includes an ejection portion, an acquisition processing portion, a detection processing portion, and an adjustment processing portion. The ejection portion includes a plurality of nozzles arranged along a width direction orthogonal to a conveying direction of a print medium and causes ink to be ejected from each of the nozzles based on the halftone image data. The acquisition processing portion acquires test halftone image data that is generated by the image generation apparatus based on test image data including a color region of a color of the ink. The detection processing portion detects a defective nozzle included in the plurality of nozzles based on a result of reading a first test image corresponding to the test halftone image data and predetermined second test images corresponding to the nozzles, the first test image and the second test images being formed on the print medium by the ejection portion. The adjustment processing portion increases an ejection amount of the ink by the nozzle adjacent to the defective nozzle detected by the detection processing portion in the width direction.

An adjustment method according to another aspect of the present disclosure is executed in an image forming apparatus which is communicably connected to an image generation apparatus which generates halftone image data and includes an ejection portion which includes a plurality of nozzles arranged along a width direction orthogonal to a conveying direction of a print medium and causes ink to be ejected from each of the nozzles based on the halftone image data, and includes an acquisition step, a detection step, and an adjustment step. The acquisition step includes acquiring test halftone image data that is generated by the image generation apparatus based on test image data including a color region of a color of the ink. The detection step includes detecting a defective nozzle included in the plurality of nozzles based on a result of reading a first test image corresponding to the test halftone image data and predetermined second test images corresponding to the nozzles, the first test image and the second test images being formed on the print medium by the ejection portion. The adjustment step includes increasing an ejection amount of the ink by the nozzle adjacent to the defective nozzle detected in the detection step in the width direction.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming system including an image forming apparatus according to an embodiment of the present disclosure;

FIG. 2 is a diagram showing a configuration of an image forming portion of the image forming apparatus according to the embodiment of the present disclosure;

FIG. 3 is a diagram showing an example of test image data used in the image forming apparatus according to the embodiment of the present disclosure;

FIG. 4 is a diagram showing an example of a first test image and second test images that are formed by the image forming apparatus according to the embodiment of the present disclosure;

FIG. 5 is a diagram showing an example of the second test image formed by the image forming apparatus according to the embodiment of the present disclosure; and

FIG. 6 is a flowchart showing an example of defective nozzle detection processing executed by the image forming apparatus according to the embodiment of the present disclosure.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### [Configuration of Image Forming System 100]

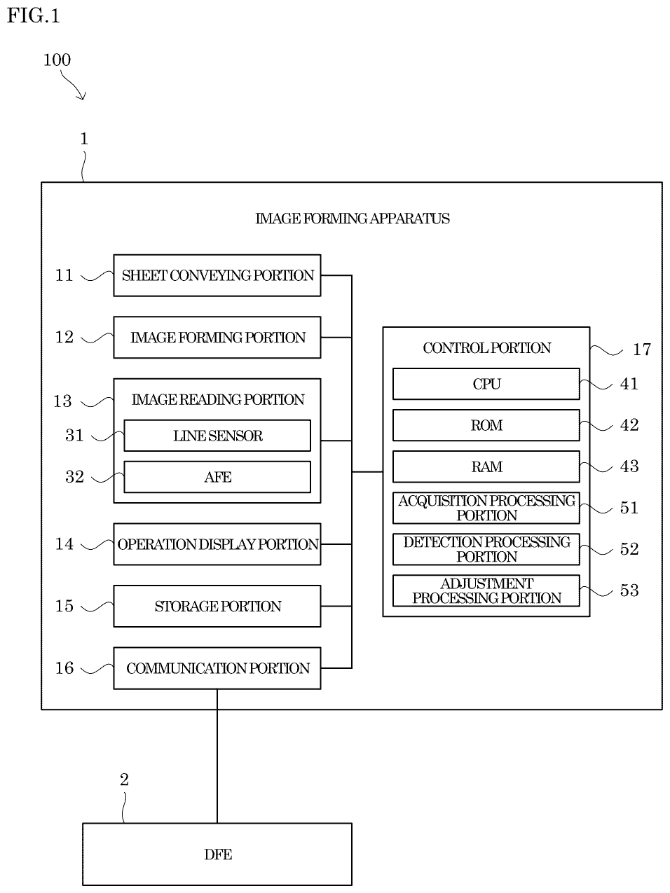

First, a configuration of an image forming system 100 including an image forming apparatus 1 according to the embodiment of the present disclosure will be described with reference to FIG. 1.

As shown in FIG. 1, the image forming system 100 includes the image forming apparatus 1 and a DFE (Digital Front End) 2.

In the image forming system 100, the image forming apparatus 1 and the DFE 2 are communicably connected to each other via a communication network such as a LAN (Local Area Network).

The image forming apparatus 1 is a printer that forms an image on a print medium such as a sheet using an inkjet method. For example, the image forming apparatus 1 is a production printer. For example, the image forming apparatus 1 forms an image on a sheet. It is noted that the print medium may be cloth, a plastic film, or the like.

The DFE 2 is an image processing apparatus that generates halftone image data based on document sheet data to be printed. The image forming apparatus 1 forms an image on a sheet based on the halftone image data generated by the DFE 2. The DFE 2 is an example of an image generation apparatus according to the present disclosure.

Specifically, the DFE 2 executes rasterization processing for changing a data format of the document sheet data into a raster format. The DFE 2 also executes screen processing for generating the halftone image data based on the document sheet data that has been converted into the raster format. For example, the DFE 2 executes AM screen processing for changing a size of halftone dots according to gradation values expressed by the halftone dots, or FM screen processing for changing a density of the halftone dots according to the gradation values expressed by the halftone dots. The content of the screen processing executed by the DFE 2, that is, a method of generating the halftone image data, differs for each type of the DFE 2.

In the image forming system 100, the DFE 2 to be connected to the image forming apparatus 1 is switched in accordance with a type of image included in the document sheet data. Specifically, in the image forming system 100, when the document sheet data is printed, the DFE 2 capable of executing the screen processing having good compatibility with the type of image included in the document sheet data is connected to the image forming apparatus 1.

### [Configuration of Image Forming Apparatus 1]

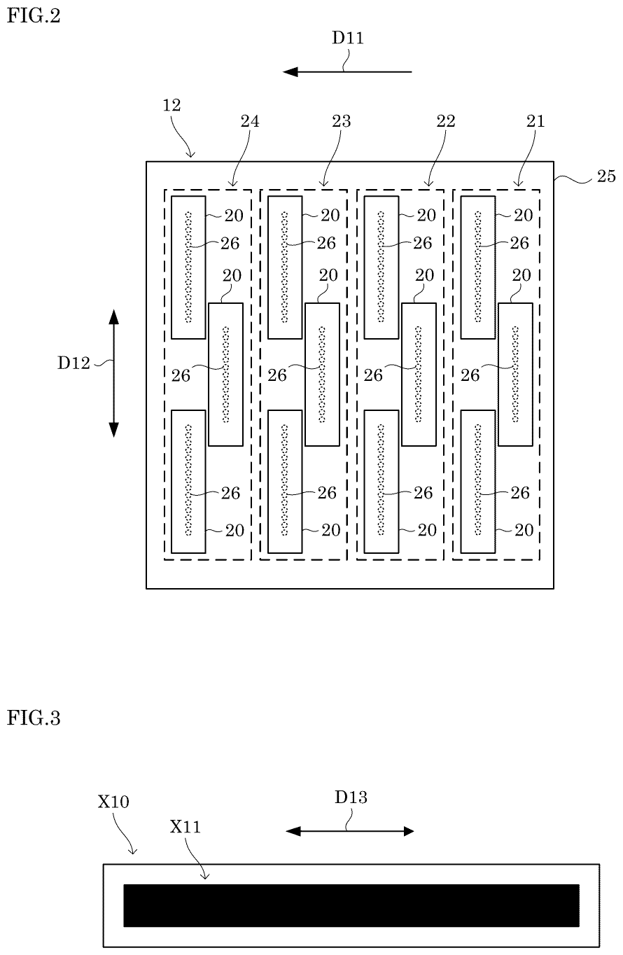

Next, a configuration of the image forming apparatus 1 according to the embodiment of the present disclosure will be described with reference to FIG. 1 and FIG. 2. FIG. 2 is a plan view showing a configuration of an image forming portion 12.

As shown in FIG. 1, the image forming apparatus 1 includes a sheet conveying portion 11, the image forming portion 12, an image reading portion 13, an operation display portion 14, a storage portion 15, a communication portion 16, and a control portion 17.

The sheet conveying portion 11 conveys a sheet stored in a sheet feed cassette (not shown) to a sheet discharge tray (not shown) via an image forming position by the image forming portion 12 and an image reading position by the image reading portion 13. The sheet conveying portion 11 includes a plurality of conveying rollers that are used for conveying the sheet.

The image forming portion 12 forms an image based on the halftone image data. Further, the image forming portion 12 forms an image on a sheet conveyed by the sheet conveying portion 11. As shown in FIG. 2, the image forming portion 12 includes line heads 21 to 24 and a head frame 25.

As shown in FIG. 2, each of the line heads 21 to 24 is elongated in a width direction D12 (see FIG. 2) orthogonal to a sheet conveying direction D11 (see FIG. 2) by the sheet conveying portion 11. Specifically, each of the line heads 21 to 24 has, in the width direction D12, a length corresponding to a width of a sheet of a maximum size out of the sheets that can be stored in the sheet feed cassette. The line heads 21 to 24 are arranged at regular intervals along the conveying direction D11.

The line head 21 ejects black ink toward the sheet conveyed by the sheet conveying portion 11. The line head 22 ejects cyan ink toward the sheet conveyed by the sheet conveying portion 11. The line head 23 ejects magenta ink toward the sheet conveyed by the sheet conveying portion 11. The line head 24 ejects yellow ink toward the sheet conveyed by the sheet conveying portion 11.

The line heads 22 to 24 have a common configuration with the line head 21 except that the colors of ink to be ejected differ. Hereinafter, descriptions will only be given on the line head 21.

As shown in FIG. 2, the line head 21 includes three recording heads 20. Each of the recording heads 20 is elongated in the width direction D12. The three recording heads 20 are arranged in a staggered pattern along the width direction D12.

A plurality of nozzles 26 (see FIG. 2) are provided on an opposing surface of each of the recording heads 20 that opposes the sheet. In each of the recording heads 20, the plurality of nozzles 26 are arranged along the width direction D12. Specifically, in each of the recording heads 20, the plurality of nozzles 26 are arranged along the width direction D12 at a density corresponding to a printing resolution of the image forming apparatus 1. For example, the plurality of nozzles 26 are arranged at regular intervals along the width direction D12. In other words, each of the recording heads 20 includes a nozzle row formed by the plurality of nozzles 26 arranged at regular intervals along the width direction D12. It is noted that each of the recording heads 20 may include a plurality of nozzle rows.

All of the nozzles 26 included in the line head 21 are arranged along the width direction D12. Specifically, the three recording heads 20 included in the line head 21 are arranged in a staggered pattern along the width direction D12 so that all of the nozzles 26 included in the line head 21 are arranged along the width direction D12 at a density corresponding to the printing resolution of the image forming apparatus 1. The line head 21 ejects ink from each of the nozzles 26 based on the halftone image data. The line head 21 is an example of an ejection portion according to the present disclosure.

Further, each of the recording heads 20 includes pressurization chambers (not shown), ejection elements (not shown), and individual flow paths (not shown) that respectively correspond to the nozzles 26. The pressurization chamber is in communication with the nozzle 26 and stores ink. The ejection element causes the ink to be ejected from the nozzle 26 in accordance with an input of a driving signal. For example, the ejection element is a piezoelectric element. The ejection element varies a pressure of the pressurization chamber in accordance with an input of the driving signal, to thus cause the ink to be ejected from the nozzle 26. The individual flow path is an ink flow path provided between the pressurization chamber and a common flow path (not shown) common to the plurality of nozzles 26. The plurality of individual flow paths respectively corresponding to the plurality of nozzles 26 are connected to the common flow path. The common flow path is connected to ink supply portions (not shown) that respectively supply ink to the pressurization chambers.

The head frame 25 supports the line heads 21 to 24. The head frame 25 is supported by a housing of the image forming apparatus 1. It is noted that the number of line heads to be provided in the image forming portion 12 only needs to be one or more. Furthermore, the number of recording heads 20 to be provided in each of the line heads 21 to 24 does not need to be limited to three.

The image reading portion 13 reads an image formed on the sheet by the image forming portion 12.

As shown in FIG. 1, the image reading portion 13 includes a line sensor 31 and an AFE (Analog Front End) 32.

The line sensor 31 is provided more on a downstream side of the conveying direction D11 than the image forming portion 12 (see FIG. 2). The line sensor 31 is capable of reading an image corresponding to one line along the width direction D12 (see FIG. 2) from the sheet conveyed by the sheet conveying portion 11. For example, the line sensor 31 is a CIS (Contact Image Sensor). The line sensor 31 includes a plurality of image pickup elements arranged next to one another in the width direction D12. Each of the image pickup elements includes a light-emitting portion and a light-receiving portion. The light-emitting portion emits light toward the sheet conveyed by the sheet conveying portion 11. The light-receiving portion is provided so as to be capable of receiving light that is emitted from the light-emitting portion and reflected by the sheet, and outputs an analog electric signal corresponding to an amount of received light. In response to a control signal input from the control portion 17, the line sensor 31 outputs an analog electric signal corresponding to an image of one line at predetermined intervals.

The AFE 32 is an electronic circuit that executes predetermined processing on the analog electric signal output from the line sensor 31. Specifically, the AFE 32 includes a signal conversion portion that converts the analog electric signal output from the line sensor 31 into a digital electric signal (image data). The AFE 32 also includes an image processing portion that executes predetermined image processing such as shading correction on the image data output from the signal conversion portion. The AFE 32 outputs image data obtained after executing the image processing, which is output from the image processing portion, to the control portion 17.

The operation display portion 14 is a user interface of the image forming apparatus 1. The operation display portion 14 includes a display portion and an operation portion. The display portion displays various types of information in response to control instructions from the control portion 17. For example, the display portion is a liquid crystal display. The operation portion is used to input various types of information to the control portion 17 according to user operations. For example, the operation portion includes a touch panel and operation keys.

The storage portion 15 is a nonvolatile storage device. For example, the storage portion 15 is a nonvolatile memory such as a flash memory.

The communication portion 16 is a communication interface that executes wired or wireless data communication with an external communication apparatus such as the DFE 2 via the communication network.

The control portion 17 collectively controls the image forming apparatus 1. As shown in FIG. 1, the control portion 17 includes a CPU 41, a ROM 42, and a RAM 43. The CPU 41 is a processor that executes various types of arithmetic processing. The ROM 42 is a nonvolatile storage device in which information such as control programs for causing the CPU 41 to execute various types of processing is stored in advance. The RAM 43 is a volatile or nonvolatile storage device that is used as a temporary storage memory (working area) for the various type of processing to be executed by the CPU 41. The CPU 41 executes the various control programs stored in advance in the ROM 42. Thus, the control portion 17 collectively controls the image forming apparatus 1.

Incidentally, there is known an image forming apparatus which detects an abnormal nozzle that cannot eject ink normally out of the nozzles 26 included in the line head 21 based on a result of reading a predetermined image that is formed on the sheet by the line head 21 and corresponds to each of the nozzles 26 of the line head 21. In this type of image forming apparatus, when the abnormal nozzle is detected, an ejection amount of the ink by the nozzle 26 adjacent to the abnormal nozzle is increased. This suppresses generation of a low-concentration streak image formed along the conveying direction D11 in the image formed by the image forming apparatus.

Herein, in the image forming apparatus, even when the ejection amount of the ink by the nozzle 26 adjacent to the abnormal nozzle is not increased, a low-concentration streak image may not be generated in the image formed by the image forming apparatus depending on the method of generating the halftone image data. Herein, when the ejection amount of the ink by the nozzle 26 adjacent to the abnormal nozzle is increased in a case where a low-concentration streak image is not generated in the image formed by the image forming apparatus even when the ejection amount of the ink by the nozzle 26 adjacent to the abnormal nozzle is not increased, a high-concentration streak image formed along the conveying direction D11 may be generated in the image formed by the image forming apparatus.

In contrast, in the image forming apparatus 1 according to the embodiment of the present disclosure, the generation of a streak image can be suppressed as will be described below.

### [Functional Configuration of Control Portion 17]

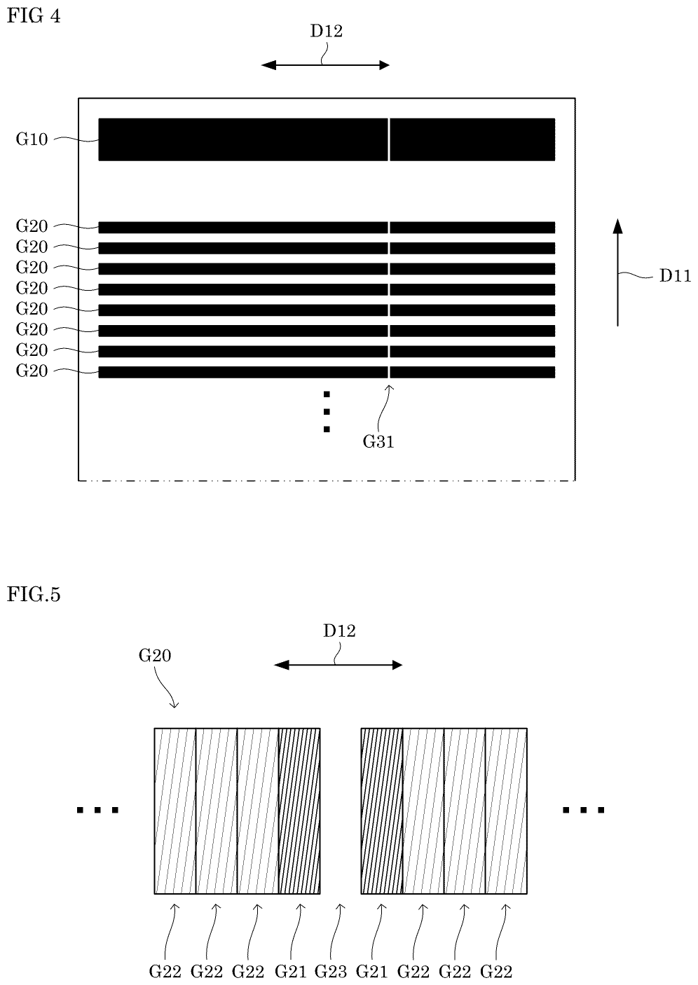

Next, a functional configuration of the control portion 17 will be described with reference to FIG. 1 and FIG. 3 to FIG. 5. FIG. 3 is a diagram showing test image data X10. FIG. 4 is a diagram showing a first test image G10 and a plurality of second test images G20 formed on a sheet by the image forming apparatus 1. FIG. 5 is a partially-enlarged view of the second test image G20.

As shown in FIG. 1, the control portion 17 includes an acquisition processing portion 51, a detection processing portion 52, and an adjustment processing portion 53.

Specifically, an operation control program for causing the CPU 41 to function as the respective processing portions described above is stored in advance in the ROM 42 of the control portion 17. Then, the CPU 41 executes the operation control program stored in the ROM 42 to function as the respective processing portions described above.

It is noted that the operation control program may be recorded on a computer-readable recording medium such as a CD, a DVD, or a flash memory and read from the recording medium to be installed in a storage device such as the storage portion 15. Further, some or all of the processing portions included in the control portion 17 may be constituted of an electronic circuit. Alternatively, the operation control program may be a program for causing a plurality of processors to function as the respective processing portions included in the control portion 17.

The acquisition processing portion 51 acquires test halftone image data that is generated by the DFE 2 based on the test image data X10 (see FIG. 3) including a black color region X11 (see FIG. 3).

As shown in FIG. 3, the color region X11 is a strip-like region elongated in a main scanning direction D13 (see FIG. 3) corresponding to the width direction D12. For example, the test image data X10 is image data in a raster format that includes only black color components. In addition, the color region X11 is a monochromatic region constituted of pixels having a predetermined concentration.

The concentration of the pixels included in the color region X11 (black concentration) is preset at a time of factory shipment of the image forming apparatus 1. It is noted that the concentration of the pixels included in the color region X11 may be set arbitrarily in accordance with a user operation made on the operation display portion 14. Alternatively, the concentration of the pixels included in the color region X11 may be set to the same concentration as a darkest pixel in color component data corresponding to black out of four pieces of color component data respectively corresponding to cyan, magenta, yellow, and black that are included in the document sheet data to be printed.

For example, in the image forming apparatus 1, the test image data X10 is stored in advance in the storage portion 15.

For example, the acquisition processing portion 51 transmits the test image data X10 to the DFE 2 and requests the DFE 2 to transmit the test halftone image data that is generated based on the test image data X10. Then, the acquisition processing portion 51 receives the test halftone image data transmitted from the DFE 2 in response to the request from the acquisition processing portion 51.

The detection processing portion 52 detects a defective nozzle included in the plurality of nozzles 26 provided in the line head 21 based on a result of reading the first test image G10 (see FIG. 4) corresponding to the test halftone image data and the second test images G20 (see FIG. 4) corresponding to the nozzles 26 included in the line head 21, the first test image G10 and the second test images G20 being formed on the sheet by the line head 21.

As shown in FIG. 4, the first test image G10 is a strip-like image corresponding to the color region X11 of the test image data X10. The first test image G10 is an image formed using black ink. The color concentration of the first test image G10 is expressed by black halftone dots.

As shown in FIG. 4, each of the second test images G20 is a strip-like image formed along the width direction D12. Specifically, each of the second test images G20 is a strip-like image that is formed along the width direction D12 and is formed by ejecting the ink from each of the nozzles 26 obtained by excluding a target nozzle corresponding to the second test image G20 from the plurality of nozzles 26 included in the line head 21, and is an image formed by causing a larger amount of ink to be ejected from the nozzle 26 adjacent to the target nozzle than the other nozzles 26.

FIG. 5 shows some of the second test images G20 formed by some of the nozzles 26 including the target nozzle out of the nozzles 26 included in the line head 21. A pair of first regions G21 (see FIG. 5) included in the second test image G20 are formed by the pair of nozzles 26 adjacent to the target nozzle. Second regions G22 (see FIG. 5) included in the second test image G20 are formed by the nozzles 26 different from the target nozzle and the pair of nozzles 26 adjacent to the target nozzle. The second regions G22 are each a region having a lower black concentration than the first region G21. A third region G23 (see FIG. 5) is formed between the pair of first regions G21 by not ejecting ink from the target nozzle. The third region G23 is a region in the same color as the sheet.

By forming the pair of first regions G21, the concentration of the third region G23 becomes the same level as the concentration of the second regions G22 in the result of reading the second test images G20 by the image reading portion 13. In other words, the pair of first regions G21 have a function of correcting the concentration of the third region G23.

Herein, it is assumed that one abnormal nozzle is included in the line head 21. The abnormal nozzle is a nozzle 26 that cannot eject ink toward an opposing position on a sheet. For example, the abnormal nozzle is a nozzle 26 that cannot eject ink due to clogging or the like.

When the line head 21 includes one abnormal nozzle, a low-concentration streak image G31 is generated in the first test image G10 and the plurality of second test images G20 as shown in FIG. 4.

Herein, in the second test image G20 corresponding to the abnormal nozzle out of the plurality of second test images G20, the concentration of the third region G23 formed at an opposing position of the sheet that opposes the abnormal nozzle is corrected by the pair of first regions G21 on both sides of the third region G23. Therefore, in the second test image G20 corresponding to the abnormal nozzle, a streak image G31 is not generated.

Meanwhile, in the second test images G20 corresponding to the nozzles 26 other than the abnormal nozzle out of the plurality of second test images G20, the concentration of the third region G23 formed at the opposing position of the sheet that opposes the abnormal nozzle is not corrected. Therefore, in the second test images G20 corresponding to the nozzles 26 other than the abnormal nozzle, a streak image G31 is generated.

In other words, it is possible to detect the abnormal nozzle by counting the number of streak images G31 included in the second test image G20 for each of the second test images G20.

Specifically, when a count value of the number of streak images G31 in all of the second test images G20 is “0”, it can be determined that there is no abnormal nozzle.

Further, when the count value of the number of streak images G31 is “0” in any of the second test images G20, it can be determined that the nozzle 26 corresponding to the second test image G20 with the count value of “0” is the abnormal nozzle.

Furthermore, when the count value of the number of streak images G31 is “1” or more in all of the second test images G20, it can be determined that the nozzles 26 corresponding to the second test images G20 whose count values are lower than that of the other second test images G20 are the abnormal nozzles.

Herein, in the image forming apparatus 1, even when the line head 21 includes the abnormal nozzle, the streak image G31 (see FIG. 4) that is due to the abnormal nozzle may not be generated in the first test image G10 in some cases. Specifically, in the image forming apparatus 1, even when the line head 21 includes the abnormal nozzle, the streak image G31 (see FIG. 4) that is due to the abnormal nozzle may not be generated in the first test image G10 depending on the method of generating the halftone image data.

Therefore, the detection processing portion 52 detects, as the defective nozzle, the nozzle 26 corresponding to the position of the streak image G31 that is included in the first test image G10 and is formed along the conveying direction D11 out of the nozzles 26 determined as the abnormal nozzles based on the result of reading each of the second test images G20, the streak image G31 being detected based on the result of reading the first test image G10.

In other words, in the image forming apparatus 1, even if the nozzle 26 is determined to be the abnormal nozzle based on the result of reading each of the second test images G20, when the streak image G31 is not formed at a position corresponding to the nozzle 26 in the first test image G10, the nozzle 26 is not determined to be the defective nozzle.

It is noted that the detection processing portion 52 may detect the streak image G31 that is included in the first test image G10 and is formed along the conveying direction D11 based on the result of reading the first test image G10, and identify the defective nozzle corresponding to the streak image G31 based on the result of reading each of the plurality of second test images G20 that have been narrowed down based on the detection position of the streak image G31 out of the plurality of second test images G20.

Further, each of the second test images G20 may be a linear image that is formed along the conveying direction D11 and is formed by ejecting ink from only the target nozzle corresponding to the second test image G20 out of the plurality of nozzles 26 included in the line head 21.

Furthermore, the color of the color region X11 (see FIG. 3) may be cyan, magenta, or yellow. In other words, the color region X11 may be a monochromatic region constituted of cyan, magenta, or yellow pixels having a predetermined concentration. In this case, the first test image G10 and the plurality of second test images G20 only need to be formed by the corresponding one of the line heads 22 to 24. Moreover, the detection processing portion 52 only needs to detect the defective nozzle from the corresponding one of the line heads 22 to 24.

Further, the acquisition processing portion 51 may acquire the test halftone image data corresponding to the respective colors of black, cyan, magenta, and yellow. In this case, the detection processing portion 52 only needs to form the first test image G10 and the plurality of second test images G20 for each color of black, cyan, magenta, and yellow, and detect the defective nozzle included in the line heads 21 to 24.

The adjustment processing portion 53 increases the ejection amount of the ink by the nozzle 26 adjacent to the defective nozzle detected by the detection processing portion 52 in the width direction D12.

For example, the adjustment processing portion 53 increases the ejection amount of the ink by the pair of nozzles 26 adjacent to the defective nozzle in the width direction D12. Alternatively, the adjustment processing portion 53 may increase the ejection amount of the ink by one of the pair of nozzles 26 adjacent to the defective nozzle in the width direction D12. Thus, the concentration of the low-concentration streak image that is generated due to the defective nozzle is corrected. Therefore, it is possible to make the low-concentration streak image difficult to see.

For example, the adjustment processing portion 53 adjusts a voltage or waveform of the driving signal input to the ejection elements respectively corresponding to the pair of nozzles 26 adjacent to the defective nozzle in the width direction D12, to increase the ejection amount of the ink by the pair of nozzles 26.

Hereinafter, an adjustment method according to the present disclosure will be described along with exemplary procedures of respective processing executed by the control portion 17.

### [Defective Nozzle Detection Processing]

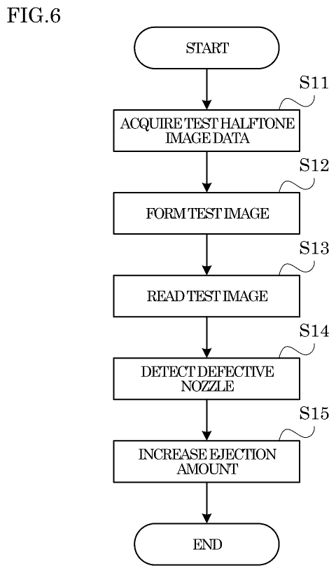

Hereinafter, exemplary procedures of defective nozzle detection processing executed by the control portion 17 in the image forming apparatus 1 will be described with reference to FIG. 6. Herein, Step S11, Step S12, . . . represent numbers of processing procedures (steps) executed by the control portion 17. It is noted that the defective nozzle detection processing is executed when an instruction to execute the defective nozzle detection processing is input via the DFE 2 from an external information processing apparatus that inputs a print job for printing the document sheet data to the image forming system 100. Alternatively, the defective nozzle detection processing may be executed when a user operation that instructs to execute the defective nozzle detection processing is accepted in the operation display portion 14.

### <Step S11>

First, in Step S11, the control portion 17 acquires the test halftone image data. The processing of Step S11 is an example of an acquisition step according to the present disclosure and is executed by the acquisition processing portion 51 of the control portion 17.

Specifically, the control portion 17 transmits the test image data X10 to the DFE 2 and requests the DFE 2 to transmit the test halftone image data that is generated based on the test image data X10. Then, the control portion 17 receives the test halftone image data transmitted from the DFE 2 in response to the request from the control portion 17.

### <Step S12>

In Step S12, the control portion 17 uses the line head 21 to form, on the sheet conveyed by the sheet conveying portion 11, the first test image G10 (see FIG. 4) corresponding to the test halftone image data acquired by the processing of Step S11 and the second test images G20 (see FIG. 4) corresponding to the nozzles 26 included in the line head 21.

### <Step S13>

In Step S13, the control portion 17 uses the image reading portion 13 to read the first test image G10 and the plurality of second test images G20 formed on the sheet by the processing of Step S12.

### <Step S14>

In Step S14, the control portion 17 detects the defective nozzle included in the plurality of nozzles 26 provided in the line head 21 based on the result of reading the first test image G10 and the plurality of second test images G20 by the processing of Step S13. The processing of Step S12 to Step S14 is an example of a detection step according to the present disclosure and is executed by the detection processing portion 52 of the control portion 17.

Specifically, the control portion 17 counts the number of streak images G31 included in each of the second test images G20 based on the result of reading the plurality of second test images G20. Further, the control portion 17 determines, for each of the nozzles 26 included in the line head 21, whether or not the nozzle 26 is the abnormal nozzle based on the result of counting the number of streak images G31 in each of the second test images G20. Then, the control portion 17 detects, as the defective nozzle, the nozzle 26 corresponding to the position of the streak image G31 included in the first test image G10 detected based on the result of reading the first test image G10 out of the nozzles 26 determined to be the abnormal nozzles.

It is noted that the control portion 17 may detect the streak image G31 included in the first test image G10 based on the result of reading the first test image G10, and specify the position of the defective nozzle corresponding to the streak image G31 based on the result of reading each of the plurality of (e.g., five) second test images G20 that have been narrowed down based on the detection position of the streak image G31 out of the plurality of second test images G20.

### <Step S15>

In Step S15, the control portion 17 increases the ejection amount of the ink by the nozzle 26 adjacent to the defective nozzle detected by the processing of Step S14.

Specifically, the control portion 17 adjusts the voltage or waveform of the driving signal input to the ejection elements respectively corresponding to the pair of nozzles 26 adjacent to the defective nozzle, to thus increase the ejection amount of the ink by the pair of nozzles 26.

In this manner, in the image forming apparatus 1, the defective nozzle is detected based on the result of reading the first test image G10 (see FIG. 4) corresponding to the test halftone image data and the second test images G20 (see FIG. 4) corresponding to the nozzles 26 included in the line head 21, that are formed on the sheet by the line head 21. Then, the ejection amount of the ink by the nozzle 26 adjacent to the defective nozzle is increased. Thus, it is possible to suppress generation of a high-concentration streak image formed along the conveying direction D11, that is due to an excessive concentration correction, as compared to a configuration in which the abnormal nozzle is detected based on the result of reading the second test images G20 (see FIG. 4) corresponding to the nozzles 26 included in the line head 21 and the ejection amount of the ink by the nozzle 26 adjacent to the abnormal nozzle is increased. Therefore, in the image forming apparatus 1, the generation of a streak image can be suppressed.

### [Notes of Disclosure]

Hereinafter, a general outline of the disclosure extracted from the embodiment described above will be noted. It is noted that the respective configurations and processing functions described in the notes below can be sorted and arbitrarily combined as appropriate.

### <Note 1>

An image forming apparatus communicably connected to an image generation apparatus which generates halftone image data, including: an ejection portion which includes a plurality of nozzles arranged along a width direction orthogonal to a conveying direction of a print medium and causes ink to be ejected from each of the nozzles based on the halftone image data; an acquisition processing portion which acquires test halftone image data that is generated by the image generation apparatus based on test image data including a color region of a color of the ink; a detection processing portion which detects a defective nozzle included in the plurality of nozzles based on a result of reading a first test image corresponding to the test halftone image data and predetermined second test images corresponding to the nozzles, the first test image and the second test images being formed on the print medium by the ejection portion; and an adjustment processing portion which increases an ejection amount of the ink by the nozzle adjacent to the defective nozzle detected by the detection processing portion in the width direction.

### <Note 2>

The image forming apparatus according to note 1, in which the detection processing portion detects, as the defective nozzle, the nozzle corresponding to a position of a streak image that is included in the first test image and is formed along the conveying direction out of the nozzles determined as abnormal nozzles that cannot eject the ink normally based on the result of reading each of the second test images, the streak image being detected based on the result of reading the first test image.

### <Note 3>

The image forming apparatus according to note 1, in which the detection processing portion detects a streak image that is included in the first test image and is formed along the conveying direction based on the result of reading the first test image, and specifies the defective nozzle corresponding to the streak image based on a result of reading each of a plurality of the second test images that have been narrowed down based on a detection position of the streak image out of the plurality of second test images.

### <Note 4>

The image forming apparatus according to any one of notes 1 to 3, in which each of the second test images is a strip-like image that is formed along the width direction and is formed by ejecting the ink from each of the nozzles obtained by excluding a target nozzle corresponding to the second test image from the plurality of nozzles, and is an image formed by causing a larger amount of the ink to be ejected from the nozzle adjacent to the target nozzle than the other nozzles.

### <Note 5>

An adjustment method executed in an image forming apparatus which is communicably connected to an image generation apparatus which generates halftone image data and includes an ejection portion which includes a plurality of nozzles arranged along a width direction orthogonal to a conveying direction of a print medium and causes ink to be ejected from each of the nozzles based on the halftone image data, the adjustment method including: an acquisition step of acquiring test halftone image data that is generated by the image generation apparatus based on test image data including a color region of a color of the ink; a detection step of detecting a defective nozzle included in the plurality of nozzles based on a result of reading a first test image corresponding to the test halftone image data and predetermined second test images corresponding to the nozzles, the first test image and the second test images being formed on the print medium by the ejection portion; and an adjustment step of increasing an ejection amount of the ink by the nozzle adjacent to the defective nozzle detected in the detection step in the width direction.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus communicably connected to an image generation apparatus which generates halftone image data, comprising:
an ejection portion which includes a plurality of nozzles arranged along a width direction orthogonal to a conveying direction of a print medium and causes ink to be ejected from each of the nozzles based on the halftone image data;
an acquisition processing portion which acquires test halftone image data that is generated by the image generation apparatus based on test image data including a color region of a color of the ink;
a detection processing portion which detects a defective nozzle included in the plurality of nozzles based on a result of reading a first test image corresponding to the test halftone image data and predetermined second test images corresponding to the nozzles, the first test image and the second test images being formed on the print medium by the ejection portion; and
an adjustment processing portion which increases an ejection amount of the ink by the nozzle adjacent to the defective nozzle detected by the detection processing portion in the width direction.

2. The image forming apparatus according to claim 1, wherein
the detection processing portion detects, as the defective nozzle, the nozzle corresponding to a position of a streak image that is included in the first test image and is formed along the conveying direction out of the nozzles determined as abnormal nozzles that cannot eject the ink normally based on the result of reading each of the second test images, the streak image being detected based on the result of reading the first test image.

3. The image forming apparatus according to claim 1, wherein
the detection processing portion detects a streak image that is included in the first test image and is formed along the conveying direction based on the result of reading the first test image, and specifies the defective nozzle corresponding to the streak image based on a result of reading each of a plurality of the second test images that have been narrowed down based on a detection position of the streak image out of the plurality of second test images.

4. The image forming apparatus according to claim 1, wherein
each of the second test images is a strip-like image that is formed along the width direction and is formed by ejecting the ink from each of the nozzles obtained by excluding a target nozzle corresponding to the second test image from the plurality of nozzles, and is an image formed by causing a larger amount of the ink to be ejected from the nozzle adjacent to the target nozzle than the other nozzles.

5. An adjustment method executed in an image forming apparatus which is communicably connected to an image generation apparatus which generates halftone image data and includes an ejection portion which includes a plurality of nozzles arranged along a width direction orthogonal to a conveying direction of a print medium and causes ink to be ejected from each of the nozzles based on the halftone image data, the adjustment method comprising:
an acquisition step of acquiring test halftone image data that is generated by the image generation apparatus based on test image data including a color region of a color of the ink;
a detection step of detecting a defective nozzle included in the plurality of nozzles based on a result of reading a first test image corresponding to the test halftone image data and predetermined second test images corresponding to the nozzles, the first test image and the second test images being formed on the print medium by the ejection portion; and
an adjustment step of increasing an ejection amount of the ink by the nozzle adjacent to the defective nozzle detected in the detection step in the width direction.
